(19) United States
(12) Patent Application Publication
(10) Pub. No.: US 2008/0256341 A1
(43) Pub. Date: Oct. 16, 2008

(54) Data Processing Pipeline Selection

(75) Inventors: Tomer Weisberg, Haifa (IL); Gurpratap Virdi, Bellevue, WA (US); Thobias Jones, Redmond, WA (US); Miguel M. Valdez, Redmond, WA (US); Alexandre V. Grigorovitch, Redmond, WA (US); Matthew Howard, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/734,254

(22) Filed: Apr. 11, 2007

(51) Int. Cl. G06F 9/30

(52) U.S. Cl. 712/220; 712/E09.016

(57) ABSTRACT

Strategies for automatically selecting the most appropriate processing pipeline (or runtime) for a particular data item are described. In one embodiment, a media playing application automatically selects the most appropriate media processing pipeline for a media data item from multiple available processing pipelines, or candidates. In this regard, the application makes this selection by utilizing heuristic techniques to identify which available pipeline provides the most enhanced playback experience to a user with respect to certain attributes such as supported playback features and security. These heuristic techniques can take one or more criteria into account and can be implemented in any suitable way. By way of example and not limitation, in one embodiment, a selection process is used wherein potential pipeline candidates are ordered and sequentially evaluated.

### BACKGROUND

As the amount of data increases, so do the available options for processing and/or rendering this data. For instance, with respect to media data in particular, as media information and media playback applications become more ubiquitous, media processing pipelines (or runtimes), used by these applications, increasingly need to support a wider variety of playback features. In the past, support for new playback features, such as digital rights management (DRM) for instance, has been added into legacy media processing pipelines that support existing playback functionalities. However, as newer playback features continue to proliferate, it is becoming impractical to keep updating and changing these legacy media processing pipelines to support each new emerging feature. Accordingly, new processing pipelines are often created to support new playback features when they become available. As a result, it is not uncommon for there to be multiple pipelines available for processing and rendering a given media data item. Furthermore, while each these pipelines might support/offer some playback features commonly, some might also support/offer certain additional playback features not available in the other pipelines.

This can make selecting a pipeline a difficult. For example, consider a situation where a legacy pipeline and a newer pipeline both support the playback of a media item. While the newer pipeline in this example supports some new playback features like HD video and DRM, it does not support as comprehensive a set of playback features as the legacy pipeline does. For instance, the newer pipeline may not support certain media editing and navigation features that the legacy pipelines supports. As such, it is not immediately clear which pipeline should be selected for playing back the media item.

One approach used by media playback applications to select a processing pipeline (from multiple available processing pipelines) is to use a default “native” pipeline unless it is incapable of playing back the media data item. Another approach is to select an available pipeline based solely on the file extension of the media data item. These approaches, however, are not optimal because they are not sophisticated enough to account for all the situational factors with respect to the given media data item, the available processing pipelines, the system implementing the processing, and the media playback application (or client). For instance, a particular media data item may require a higher level of security than one or more available pipelines can offer, or may provide extra features that are not supported by all the available pipelines. As such, simply selecting a pipeline using one of the above approaches may not provide the most enhanced user experience with respect to the media data item.

Still another approach is to leave the choice of which processing pipeline to use to a user. However, this is not optimal because it would require a user to be knowledgeable about the media data item and the specific features of each pipeline available at the time. Furthermore, given the number of media data items available to a typical user for playback, this would be inconvenient and impractical and would ultimately diminish the user's overall playback experience.

Accordingly, there is a need to intelligently and automatically select the most appropriate processing pipeline for a particular data item, such as a media data item, without requiring that a user manually participate in the selection process.

### SUMMARY

Strategies for automatically selecting the most appropriate processing pipeline (or runtime) for a particular data item are described. In one embodiment, a media playing application automatically selects the most appropriate media processing pipeline for a media data item from multiple available processing pipelines, or candidates. In this regard, the application makes this selection by utilizing heuristic techniques to identify which available pipeline provides the most enhanced playback experience to a user with respect to certain attributes such as supported playback features and security. These heuristic techniques, which take the multiple pertinent criteria into account, can be implemented in any suitable way. By way of example and not limitation, in one embodiment, a selection process is used wherein potential pipeline candidates are ordered and sequentially evaluated based on the multiple pertinent criteria.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. In the figures, the left-most digit of a reference number identifies the figure in which the reference number first appears. The use of the same reference numbers in different figures indicates similar or identical items.

FIG. 1 illustrates an exemplary computing environment for implementing the disclosed heuristic techniques.

FIG. 2 illustrates an exemplary system in accordance with one embodiment.

FIG. 3 illustrates an exemplary process for implementing the disclosed heuristic pipeline selection techniques.

FIG. 4 illustrates an exemplary rule-based logic in the form of a flow diagram depicting a process that utilizes the disclosed heuristic pipeline selection techniques.

### DETAILED DESCRIPTION

This disclosure is directed to utilizing heuristic techniques to identify/select which of multiple available data processing pipelines (or runtimes) provides the best experience to the user with respect to certain attributes such as available playback features and security. These heuristic techniques take one or more core criteria into account which, without limitation, can include: whether a possible processing pipeline (or runtime) provides an acceptable level of security for the data item, whether it accommodates requirements associated with the data item's metadata, whether it accommodates requirements associated with the data item's content and whether the pipeline candidate accommodates requirements of the client of the pipeline (i.e., the media player application and or other applications utilizing the media player application). For purposes of this discussion, a client can be considered to be any application, or user of that application, utilizing a processing pipeline (or runtime) to process and/or render data. In the context of media data, this processing and rendering is directed to making the data available for presentation to a user in the form of uncompressed bits.

Furthermore, these heuristic techniques can be implemented in any suitable way. By way of example and not limitation, in at least some embodiments, a process of elimination is used wherein multiple pipelines are queued for evaluation in an order that is based upon how new the playback features they support are. In other words, a pipeline candidate that supports one or more features that have been made available more recently is evaluated before a candidate that supports one or more features that have been made available less recently. This evaluation includes determining whether a candidate satisfies one or more criteria, such as the one or more of the criteria described above for instance. Pipeline candidates that do not satisfy these criteria are eliminated as candidates and are not selected. Finally, the first candidate to satisfy these criteria is selected as the pipeline to use for processing the media data item.

Multiple and varied implementations and embodiments are described below. Generally, any of the functions described with reference to the figures can be implemented using software, firmware (e.g., fixed logic circuitry), manual processing, or a combination of these implementations. The term “logic, “module” or “functionality” as used herein generally represents software, firmware, or a combination of software and firmware. For instance, in the case of a software implementation, the term “logic,” “module,” or “functionality” represents program code (or declarative content) that performs specified tasks when executed on a processing device or devices (e.g., CPU or CPUs). The program code can be stored in one or more computer readable memory devices. More generally, the illustrated separation of logic, modules and functionality into distinct units may reflect an actual physical grouping and allocation of such software and/or hardware, or can correspond to a conceptual allocation of different tasks performed by a single software program and/or hardware unit. The illustrated logic, modules and functionality can be located at a single site (e.g., as implemented by a processing device), or can be distributed over multiple locations (e.g., as implemented by multiple processing devices).

Exemplary Computing Environment

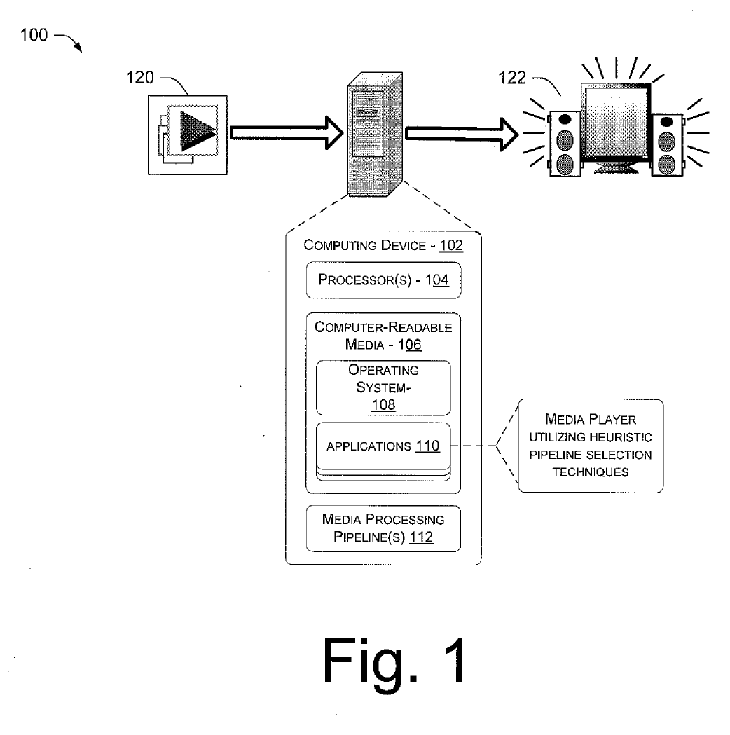

FIG. 1 illustrates an exemplary computing environment 100 for implementing the disclosed heuristic techniques. It is to be appreciated that computing environment 100 is but one example of a suitable computing environment and is not intended to suggest any limitation as to the scope of use or functionality of the system. As such, the various described embodiments can be operational with numerous other general purpose or special purpose computing system environments or configurations. Neither should computing environment 100 be interpreted as having any dependency or requirement relating to any one or combination of components illustrated therein.

Computing environment 100 includes, in this example, one or more computing devices 102. Although computing device 102 is illustrated in the form of a desktop computer, it is to be appreciated and understood that one or more other suitable computing devices can be utilized without departing from the spirit and scope of the claimed subject matter. Other suitable computing devices can include, by way of example and not limitation, portable computers, handheld computers such as personal digital assistants (PDAs), cell phones, tablet computers, smart phones and the like.

One or more computing devices 102 are capable of implementing one or more media processing pipelines for processing and rendering media data, each of which includes one or more processors 104 and one or more computer-readable media 106. One or more computer-readable media 106 in turn includes operating system 108 and one or more software applications 110, both of which are executable by the processor(s). The applications can comprise any suitable type of applications including those that present, as part of their functionality, a media player capable of implementing the disclosed heuristic techniques for selecting which of multiple available processing pipelines provides the most enhanced playback experience with respect to certain attributes such as supported playback features and security.

Here it should be noted that while computing environment 100 is described in the context of media processing and includes media processing pipelines, it is to be appreciated and understood that computing environment 100 can be employed in other contexts involving other types of data pipelines without departing from the spirit and scope of the claimed subject matter.

One or more computing devices 102 also include one or more media processing pipelines 112. For the purposes of this discussion, a media processing pipeline can generally be thought of as the functionality used to play back media data. This includes any functionality affecting the media data between the operations of reading compressed or uncompressed bits of a media data item and presenting the uncompressed bits to a user. More specifically, a media processing pipeline can be thought of as a processing and rendering path defined by a series of components that perform calculations and operations on bits comprising a media data item (including any components responsible for moving the bits between components) such that the bits (and hence the media item) are ultimately presented in an uncompressed form. Media processing pipelines typically comprise multiple components that can be any combination of software, hardware and firmware.

Typically, as will be appreciated and understood by one skilled in the art, media processing pipeline components are located at a level in the computing environment that is lower than the level of the one or more software applications 110. However, this is not always the case. For instance, in at least some embodiments, a first media application, or “client” of a media processing pipeline, (such as a media player application) will itself be used by a second media application to manage the processing and/or rendering of one or more media data items. In this respect, the first application in effect becomes a component of the media processing pipeline and the second application effectively also becomes a “client” of the media processing pipeline. By way of example and not limitation, Windows Media Center® might utilize Windows Media Player® itself to process and render certain media items to be presented.

System 100 also includes media data item 120 which can be compressed or uncompressed media information capable of being processed and rendered by one of the media processing pipelines 112. For the purposes of this discussion, media data items can be thought of any information that conveys audio and/or video information, such as audio resources (e.g., music, spoken word subject matter, etc.), still picture resources (e.g., digital photographs, etc.), moving picture resources (e.g., audio-visual television media programs, movies, etc.), and the like. Furthermore, media data items can be in any suitable form such as media files, DVDs, network-accessible sources of media information or the like and may contain a mixture of protected content and unprotected content.

Finally, in this illustration, media item 120 is depicted as being presented for consumption by a user via one or more output devices 122. In this regard, output devices 122 can be any suitable device(s) such as a monitor and/or speakers, projection device or the like configured to present uncompressed bits comprising the media item to a user.

Exemplary System

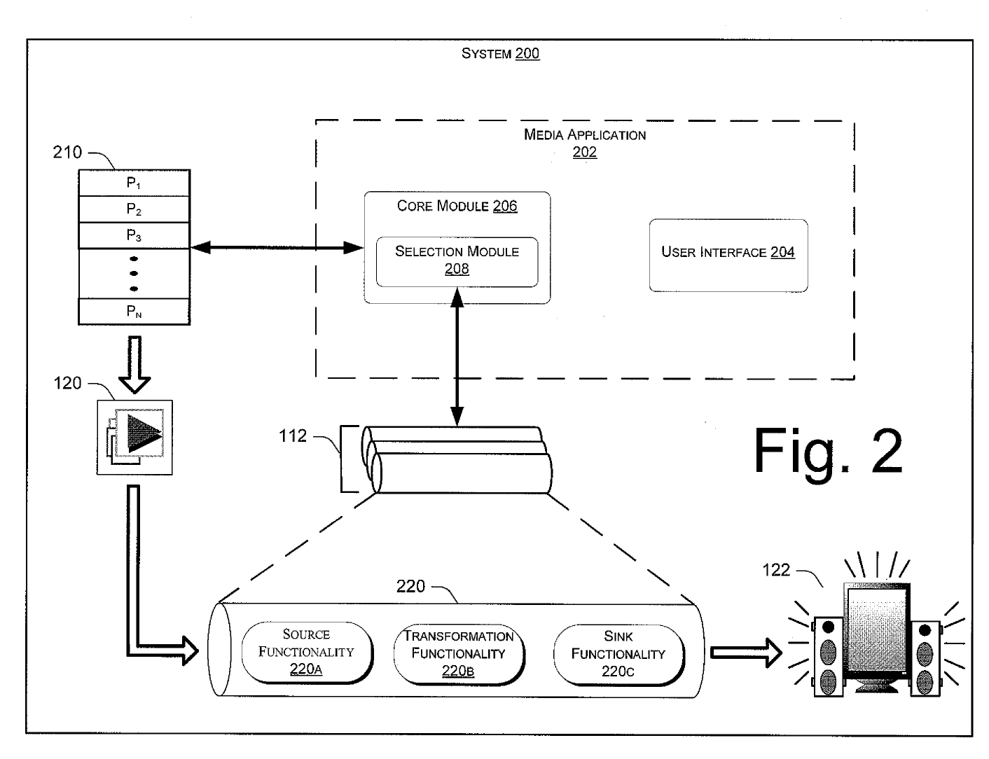

FIG. 2 illustrates an exemplary system 200 in accordance with one embodiment. System 200 can be implemented, at least in part, by one or more suitable computing devices, such as computing device(s) 102 described above. In this regard and for discussion purposes, system 200 is described with reference to the exemplary computing environment 100 described above. Additionally, it should be noted that while system 200 is described in the context of media data processing, it is to be appreciated and understood that system 200 can be employed in other contexts involving other types of data processing without departing from the spirit and scope of the claimed subject matter.

The system 200 includes a media player application 202, such as Windows Media Player®, Quicktime® or RealPlayer® for example, which is responsible for initiating and managing the playback (processing, rendering and presentation) of media data. For the purposes of this discussion, the media player application 202 can be conceptualized as including three broad functionalities. First, media player application 202 provides a user interface (UI), such as UI 204 depicted here, with various user controls such as command buttons, selection windows, dialog boxes and the like to facilitate interaction with, and presentation to, a user of the system 200.

A second broad functionality of the media player application 202 is that it coordinates and otherwise manages one or more sources of media data, such as incoming media data (downloaded) and/or a media library (e.g., one or more playlists specifying a plurality of media data items) associated with system 200, as will be appreciated and understood by one skilled in the art. This media data can include, without limitation, media data content and/or metadata associated with the data.

To perform these and other management functions, media player application 202 includes a core module, here depicted as core module 206. The core module 206 represents a general container that provides various functions associated with the processing and rendering of media data. By way of example and not limitation, in addition to the download and media library management described above, these various functions can include CD “ripping” management, caption management, license acquisition management, CD enumeration, subscription management, and the like. In the context of this disclosure, one module of particular interest in the core module 122 is a selection module 208, described in more detail below, which determines which media pipeline (processing and rendering path) is to be used for a particular media data item.

Here, one such source of media data is depicted as media playlist 210 that specifies a plurality of media data items (P1, P2, . . . Pn). As noted above, these media data items may represent files, DVD selections, network-accessible media information or the like and may have different formats associated therewith. Additionally, some or all of these media data items may be protected or unprotected and/or compressed or uncompressed. In this regard, and for the purposes of this discussion, playlist 210 can be considered the source of media data item 120, here depicted as being played back (processed and rendered) by system 200.

A third broad functionality of the media player application 202 is to coordinate and otherwise manage the actual processing and rendering of media data. As described above, this is typically accomplished by utilizing one or more media processing pipelines for transitioning media data to uncompressed presented bits. In this regard, the media player application 202 can be thought of as a client of each available pipeline. Furthermore, as will be understood by one skilled in the art, different media items can be processed by different pipelines and then combined and rendered as a single presentation experience. For example, media data can include multiple media items that can be processed separately by different paths and then combined so as to accomplish transitional effects.

To coordinate and otherwise manage this processing and rendering, media player application 202 utilizes the core module 206 described above. In this regard, the core module 206 includes the selection module 208 which is used to determine which media processing pipeline (i.e., processing and rendering path) is to be used for a particular media data item, such as media data item 120 depicted here. To accomplish this, a module of the player application 202, such as the selection module 208 for example, assesses the system 200 and identifies which, if any, media processing pipelines (paths) are available in system 200. In this regard, it should be noted that any number of media processing pipelines might be available without deviating from the spirit and scope of the claimed subject matter. Here, the available media processing pipelines are depicted as media processing pipelines 112.

Once a module of the player application 202 has assessed the system 200 and identified the available media processing pipelines 112, the selection module 208 can then utilize the disclosed heuristic pipeline selection techniques to evaluate the available media processing pipelines 112 and select the most appropriate media processing path, here depicted as media processing pipeline 220. As explained above, to accomplish this, the selection module 208 can utilize heuristic techniques that take multiple criteria, or factors, into account. Without limitation, these criteria/factors can include: whether an available processing pipeline (i.e., candidate) provides an acceptable level of security for the data item's content, whether it accommodates requirements associated with the data item's metadata, whether it accommodates requirements associated with the data item's content and whether it accommodates requirements of the client of the pipeline (i.e., the media player application and or other applications utilizing the media player application).

To facilitate the reader's understanding of this discussion, media processing pipeline 220 is depicted here as including three types of functional components. The source functionality component 220a supplies media data from one or more sources of media information. One exemplary component of the source functionality component is a decoding component (not shown) which decodes media data that is encoded. In this example, the media data comprises media data item 120 and the source of media information is playlist 210. The transformation functionality component 220b performs intermediary processing to transform the media information from one form to another (e.g., resizing, changing color space, adding effects such as Sound Retrieval System (SRS) WOW effects and the like). The sink functionality component 220c supplies the output of the transformation functionality 208 to the one or more presentation devices 222 for presentation to a user. One or more presentation devices 230 can be any suitable output devices(s) for presenting the uncompressed bits comprising the media item to a user, such as a monitor, speakers or the like. Sink functionality component 220c can comprise any suitable modules including a rendering module (not shown) which may in turn comprise a mixer module (not shown) and a presenter module (not shown), as will be appreciated and understood by one skilled in the art.

Finally, in this illustration, media item 120 is depicted as being presented for consumption by a user via one or more output devices 122. As noted above, output devices 122 can be any suitable device(s) such as a monitor and/or speakers, projection device, or the like.

Exemplary Process

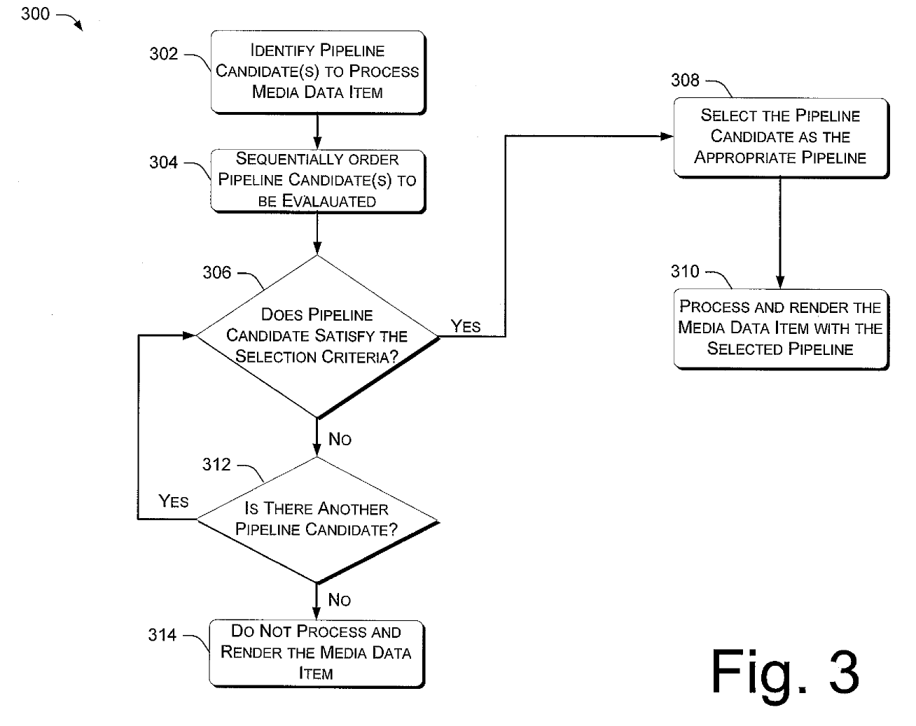

FIG. 3 illustrates an exemplary process 300 for implementing the disclosed heuristic pipeline selection techniques on one or more suitable computing devices, such as computing device(s) 102 described above. The process 300 is illustrated as a collection of blocks in a logical flow graph, which represents a sequence of operations that can be implemented in hardware, software, or a combination thereof. In the context of software, the blocks represent computer instructions that, when executed by one or more processors, perform the recited operations. The order in which this process is described is not intended to be construed as a limitation, and any number of the described blocks can be combined in any order to implement the process, or an alternate process. Additionally, individual blocks may be deleted from the process without departing from the spirit and scope of the subject matter described herein.

It should be noted that while the process 300 is described in the context of a runtime that is a media processing pipeline, it is to be appreciated and understood that the disclosed process can be employed in other contexts involving other types of data pipelines without departing from the spirit and scope of the claimed subject matter. By way of example and not limitation, the disclosed method might be employed in the context of a networking environment wherein different runtimes might represent different processing pipelines with distinct but potentially overlapping functionality, such as pipelines that utilize various Internet Protocol (IP) versions (e.g., IP version 4 and IP version 6) for example.

At block 302, one or more media processing pipeline candidates, such as media processing pipelines 112 above, configured to process a media item are identified. This operation can be accomplished in any suitable way, as will be understood and appreciated by one skilled in the art. For example, in at least some embodiments, a media player application can utilize an ordered list of available media processing pipelines to identify one or more candidates. For the purposes of this discussion, a media processing pipeline candidate can be thought of as any media processing pipeline that is available to a media processing system. In this regard, various media processing pipelines may or may not support any number of playback features and can vary in the scope of overall features they support. In other words, media processing pipeline candidates may overlap with respect to what playback features they support or, alternatively, may not overlap at all in this regard. One commercially available example of multiple media processing pipeline candidates are three media processing pipelines provided by Microsoft® Corporation of Redmond, Wash. Specifically, Windows DirectShow® is a media processing pipeline that supports a wider range of media playback features than the two pipelines described below. Windows DirectShow® Windows Media Format SDK (FSDK)® is a media processing pipeline that offers advanced support for Windows Media Formats such as Windows Media Audio® (WMA) and Windows Media Video® (WMV). Finally, Windows Media Foundation® (MF) supports certain premium technologies such as HD video and a higher security level for DRM (as compared to that provided by FSDK), but does not support as wide a range of features as the Windows DirectShow® or FSDK pipelines do.

Additionally, the availability of some or all features supported by a given media processing pipeline candidate may depend, at least in part, on the computing environment in which that pipeline candidate is implemented. In this regard, a particular media processing pipeline may have multiple modes of operation (which may be mutually exclusive), each of which supports a different set of playback features (possibly overlapping) and/or security features, while still using the same underlying technology. As such, each mode can be evaluated as if it were a distinct pipeline candidate by utilizing the disclosed pipeline selection techniques. One commercially available example of this is the Windows MFT pipeline which can be operated in a secure mode (which utilizes the code integrity and secure process features of the Windows Vista® operating system which are required by DRM technology), an insecure mode (which utilizes techniques similar to the secure mode but in a relaxed form which is suitable for plug-ins and other extensible techniques) and an in-process mode (which supports clients that require a smaller footprint or have strict customization requirements such as custom rendering for instance).

At block 304 the media processing pipeline candidate(s) are sequentially ordered to be evaluated. The position in which each pipeline candidate is ordered relative to the other pipeline candidates determines when that pipeline will be evaluated with respect to the other pipeline candidates. This evaluation can be thought of as a process of determining whether or not a pipeline candidate satisfies certain selection criteria, which will be described in detail below. Any suitable technique can be employed for determining how the pipeline candidates are ordered for evaluation. For example, as noted above, in at least some embodiments, the order in which each pipeline candidate is evaluated is based on which playback features each pipeline supports.

Continuing, at block 306 a determination is made whether the pipeline being evaluated satisfies certain selection criteria. Any suitable selection criteria, or factors, can be utilized such that an appropriate pipeline candidate can be identified and selected. For example, in at least some embodiments, criteria is used that is directed to insuring that a selected pipeline candidate provides an enhanced user playback experience (regarding playback features, Codec availability, security, etc.) with respect to the media data item and the available pipeline candidates. In this regard, the possibility of selecting the pipeline candidate associated with the most enhanced playback experience is increased by virtue of the fact that the order in which the pipeline is evaluated is based upon how new the playback features they support are. This is because in at least some embodiments, it can be presumed that there is a positive correlation between how recently been developed or otherwise modified to support a newer playback feature(s) and the likelihood that that pipeline will provide an enhanced user playback experience relative to the other pipeline candidates. Furthermore, by virtue of the fact that each pipeline candidate is still evaluated with respect to certain criteria (described in detail below), the possibility of selecting a newer pipeline candidate that provides a lower overall level of user playback experience relative to the other pipeline candidates is minimized.

By way of example and not limitation, one or more of the following criteria, described briefly above, can be utilized in an exemplary implementation:

“Security Criteria” these criteria are directed to determining whether a particular pipeline (runtime) candidate, and the one or more computing devices implementing the pipeline candidate, provides an acceptable level of security for the media data item. For purposes of this discussion, the term security can be thought of as the inability of an unauthorized entity to access the content of the media data item. Typically, the security level required for the media data item is designated by metadata associated with the media content of the media data item. This information is then typically used by a client (i.e., a media player application attempting to playback the media data item and/or other applications(s) utilizing the media player application) to determine whether or not a pipeline candidate being evaluated supports the level of security that is required to process and render the media data item. This can be accomplished in any suitable way. For example, in at least some embodiments a DRM subsystem associated with the client determines whether or not a particular pipeline candidate being evaluated and/or the one or more computing devices implementing the pipeline candidate provides this level of security.

“Metadata Criteria”—these criteria can involve the delivery mechanism and/or description of the content and are directed to determining whether a particular pipeline (runtime) candidate supports specific requirements associated with (i.e., articulated in) the metadata of the media data item. For purposes of this discussion, the metadata of a data item can be thought of as any information other than the actual pixels comprising the item's content. As such, the file extension of an item (e.g., .avi, .wmp, etc.) and/or information in the header of the packet the item is delivered in can constitute metadata. For example, the metadata of a media data item may indicate that the item's content should be processed and rendered by one or more specific media processing pipelines, that the content must be streamed to the client in a particular way, or that certain playback features must be supported by the processing and rendering pipeline. As such, a determination can be made by the client whether or not a pipeline candidate being evaluated is able to accommodate such requirements.

“Content Criteria”—these criteria involve the content type and other content characteristics and is directed to determining whether a particular pipeline (runtime) candidate supports and is otherwise able to process and render the content of the media data item. For example, the content may be encoded, compressed or otherwise formatted in a particular fashion. Alternatively or additionally, the content may require that certain playback features be supported by the processing and rendering pipeline. As such, a determination can be made by the client whether or not a pipeline candidate being evaluated supports and is otherwise able to process and render the content.

“Client Criteria” these criteria involve the client (i.e., a media player application attempting to playback the media data item and/or other applications(s) utilizing the media player application) of the media processing pipeline candidate(s) and is directed to determining whether a particular pipeline (runtime) supports certain requirements of the client. By way of example and not limitation, a user of the client may wish to set certain client—specific modifiers on the media data item such as adding a tag on the end of a uniform resource locator (URL) associated with the media data item (e.g., “WMHME=1”) and/or modifying the prefix scheme (e.g. “http:”) of the URL for instance. Alternatively and/or additionally, a client may have certain special processing requirements that need to be supported in order for the media data item to be processed and rendered, such as in-process vs. out-of-process requirements or custom-rendering vs. default rendering requirements, as will be understood and appreciated by one skilled in the art.

If, at block 306, it is determined that the pipeline candidate being evaluated does not satisfy the selection criteria (“No”), then the flow diagram 300 proceeds to block 312, discussed below. However, if it is determined that the pipeline candidate does satisfy the selection criteria (“Yes”), then at block 308 that pipeline candidate is selected as the appropriate pipeline. Subsequently, at block 310, the media data item is processed and rendered by the first pipeline.

Referring now to block 312, if it is determined that the pipeline candidate being evaluated does not satisfy the selection criteria, a determination is made whether there is another pipeline candidate available. As noted above, this determination can be accomplished by any suitable technique and any number of media processing pipelines might be available in a media processing system, such as system 200 above. Furthermore, since the pipeline candidates are sequentially ordered at block 304, the next pipeline candidate to be evaluated, if there is one, has already been determined.

If it is determined that there is another pipeline candidate available (“Yes”), then the flow diagram 300 loops back to block 306 where a determination is made whether the next pipeline candidate being evaluated satisfies the selection criteria. This process of looping back to block 306 can occur any number of times until it is determined that that there is not another pipeline candidate available (“No”). If it is determined that there is not another pipeline candidate available, then at block 314 the media data item is not processed and rendered by the first pipeline candidate. In this regard, any means deemed appropriate for dealing with this situation can be implemented. For example, the client can communicate to a user, by way of an error code or other indicia, that the media data item cannot be processed and rendered. Alternatively or additionally, steps can be taken to make a new pipeline candidate available.

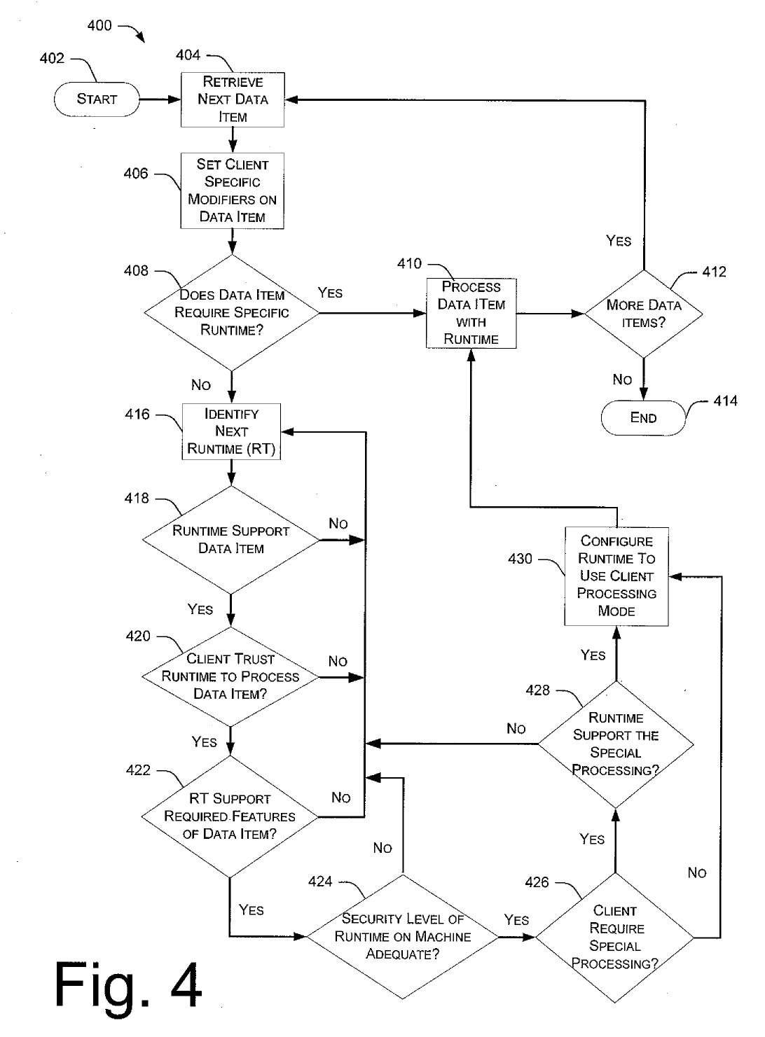

FIG. 4 illustrates exemplary rule-based logic in the form of a flow diagram depicting a process 400 utilizing the criteria and heuristic techniques described above to select a runtime (from one or more runtime candidates) for processing a data source. These runtime candidates can comprise any suitable type of data processing pipelines with distinct but potentially overlapping functionality. As but one example, these runtime candidates can be media processing pipelines for processing a media data item, as described above. Alternatively, these runtime candidates can be other types of data processing pipelines, such as pipelines that utilize various IP versions for example.

Process 400 can be implemented, at least in part, by one or more suitable computing devices, such as computing device(s) 102 described above. Since, process 400 is but one example of how the principles and methods described above can be implemented, it is to be appreciated and understood that other means of implementing the described embodiments can be utilized without departing from the spirit and scope of the claimed subject matter.

At block 402, a process 400 is started. Process 400 can be started responsive to any suitable stimulus, such as automatically when data is received or manually when a user performs an action such as selecting data, browsing a station, or starting an application for example. Once process 400 is started, at block 404 the next data item to be processed is retrieved. For example, in some circumstances, a sequence of data items might be available from a single source, such as a playlist for instance. For purposes of this discussion, the next data item can be thought of as the next discreet piece of information that includes content to be processed. In this regard, the next data item may also include metadata which is additional information associated with the content that is not part of the content itself. Furthermore, the data item can be retrieved in any suitable way, such as by reading a file or playlist comprising the data or specifying the data.

At block 406, any client-specific modifiers are set on the data item, as will be appreciated and understood by one skilled in the art. These modifiers can be set by a client application and/or a user of the client application, as will be appreciated and understood by one skilled in the art. For the purposes of this discussion, client specific modifiers can be thought of as any changes to the data item that are required by a client. By way of example and not limitation, this can include changes to a tag on the end of a URL associated with the media data item (e.g., “?WMHME=1”) and/or modifying the prefix scheme (e.g., “http:”) of the URL for instance. As such, block 406 effectively introduces the “client criteria” described above.

After any client specific modifiers are set, at block 408 a determination is made whether the data item requires a specific runtime. This determination can be made by in any suitable way. By way of example and not limitation, the data item's metadata or the content itself can provide an indication that a specific runtime is required. As such, block 408 effectively introduces the “metadata criteria” described above. If it is determined that the data item does not require a specific runtime (“No”), then the process 400 proceeds to block 416, discussed below. However, if it determined that the data item does require a specific runtime (“Yes”), then at block 410 the data item is processed with the specific runtime, if available. If the runtime is not available, then the data item cannot be processed (not shown).

After the data item is processed with the required runtime, at block 412 a determination is made whether there are more data items to be processed. If there are more data items to be processed (“Yes”), then at block 404 the next data item is retrieved, as described above. However, if there are not more data items to be processed (“No”), then at block 414 the process 400 ends.

Referring now to block 416, if it is determined that the data item does not require a specific runtime, then the next runtime is identified to be evaluated with respect to blocks 418-428 (described below)—which are directed to determining whether the runtime being evaluated satisfies the above-described criteria. In this regard, any suitable technique can be employed for determining the order by which each of multiple runtimes is evaluated relative to the other available runtimes. For example, as described above, in at least some embodiments, this order is based on which features each pipeline supports. As noted above, in the context of a media processing pipelines, this technique offers several advantages with respect to the likelihood that a selected runtime will provide an enhanced playback experience relative to the other available runtimes.

At block 418, a determination is made whether the runtime being evaluated supports the data item to be processed. In other words, a determination is made as to whether the runtime is capable of processing the data item based on any requirements associated with the data item's content. By way of example and not limitation, the container of the data item and/or the Codec format of the item might require certain processing features which may or may not be currently available to the runtime being evaluated. If the runtime cannot currently support the container and/or Codec, then it might not be selected to process the data item. However, if the runtime is later modified later so as to include the required processing features, it might then be selected in the future when/if a determination is again made. As an example in the context of the above described media processing pipelines provided by Microsoft Corporation®, MF® and FSDK® support Advanced Systems Format (ASF), DirectShow® supports ASF and Audio Video Interleave (AVI). MF® may support AVI in the future. What is considered is if there is a runtime, in a given install state, that support a container and/or codec pair that is required by the data item's content. For example, MF® supports ASF, but if a certain codec is not available, then FSDK® will be attempted, if that combination satisfies the condition. If AVI support does not exist in MF® today, but is added tomorrow, an application can query for this and add MF® as an option in the future (provided a codec exists).

As such, block 418 effectively introduces the “content criteria” described above. If it is determined that the runtime being evaluated does not support the data item to be processed (“No”), then process 400 loops back to block 416 wherein the next runtime to be evaluated is identified, as described above. This process of looping back to block 416 can occur any number of times until it is determined that that there is not another pipeline candidate available to process the data item, in which case process 400 ends (not shown by a block).

If it is determined that the runtime being evaluated does support the data item to be processed (“Yes”), then at block 420 it is determined whether the client trusts the runtime to process the data item. In other words, a determination is made whether the runtime provides an acceptable level of security for the media data item. As an example in the context of the above described media processing pipelines provided by Microsoft Corporation®, MF® and FSDK® and DirectShow® each may have a certain security level applied to them in certain configurations (e.g., MF® supporting L2500 and FSDK® and DirectShow® supporting L2000), As such, if a media data item has a certain security associated with it (e.g., L2500 or higher), then only those pipelines in configurations supporting that level of security or higher (MF® in this example)) will be allowed to process the data item. As such, block 420 effectively introduces the “Security Criteria” described above. If it is determined that the client does not trust the runtime to process the data item (“No”), then process 400 loops back to block 416 wherein the next runtime to be evaluated is identified, as described above. This process of looping back to block 416 can occur any number of times until it is determined that that there is not another pipeline candidate available to process the data item, in which case process 400 ends.

If it is determined that the client does trust the runtime to process the data item (“Yes”), then at block 422 it is determined whether runtime supports all, if any, of the required features of the data item. (e.g. certain navigation and/or editing features). In other words, a determination is made whether the runtime supports specific requirements associated with the metadata of the data item. As such, block 422 effectively introduces the “Content Criteria” described above. If it is determined that the runtime does not support all of the required features of the data item (“No”), then process 400 loops back to block 416 wherein the next runtime to be evaluated is identified, as described above.

If it is determined that the runtime does support all of the required features of the data item (“Yes”), then at block 424 it is determined whether the security level of the runtime on the machine is adequate. In other words, a determination is made whether the runtime, as embodied on the one or more computing devices implementing the process 400, provides an acceptable level of security for the media data item. As such, block 424 effectively introduces the “Security Criteria” described above. If it is determined that the security level of the runtime on the machine is not adequate (“No”), then process 400 loops back to block 416 wherein the next runtime to be evaluated is identified, as described above.

If it is determined that that the security level of the runtime on the machine is adequate (“Yes”), then at block 426 it is determined whether the client requires special processing. In other words, a determination is made whether the runtime can accommodate any processing or rendering requirements of any of the one or more clients which will utilize the runtime. As such, block 426 effectively introduces the “client criteria” described above. By way of example and not limitation, in the context of a media processing pipeline runtime provided by Microsoft Corporation, a client such as Media Center® might require that the runtime support special processing capabilities such as the ability for a user to manually adjust video and/or audio rendered by another application, such as Windows Media Player® for instance.

Continuing, if it is determined that the client does not require special processing, then the process 400 proceeds to block 430, described below. However, if it determined that the data item does require a specific runtime (“Yes”), then at block 428 it is determined whether the runtime supports the client's processing mode, including the special processing required by the client. If it is determined that it does not support the client's processing mode (including the special processing) (“No”), then process 400 loops back to block 416 wherein the next runtime to be evaluated is identified, as described above.

If it is determined that the runtime does support the client's processing mode (including the special processing) (“Yes”), then at block 430 the runtime is configured, if necessary, to use the client's processing mode as will be understood by one skilled in the art. The process 400 then proceeds to block 410 described above.

### CONCLUSION

Although embodiments of techniques for automatically selecting, based on multiple pertinent criteria, the most appropriate processing pipeline (or runtime) for a particular data item, such as a media data item, are described, it is to be understood that the subject of the appended claims is not necessarily limited to the specific features or methods described. Rather, the specific features and methods are disclosed as exemplary implementations.

What is claimed is:

1. One or more computer-readable media comprising computer-executable instructions that, when executed, perform acts comprising:
identifying a plurality of potential processing paths to be used to process data;
selecting a processing path from the plurality of potential processing paths based on an analysis of multiple factors for a particular user experience, wherein the factors comprise:
one or more factors associated with the security level required to protect the data;
one or more factors associated with one or more characteristics of metadata associated with the data; and
one or more factors associated with characteristics of the content of the data.

2. One or more computer-readable media as recited in claim 1, further comprising data that is media data.

3. One or more computer-readable media as recited in claim 1, further comprising a factor associated with one or more requirements of one or more clients of the potential processing paths.

4. One or more computer-readable media as recited in claim 1, wherein the one or more factors associated with the security level take into account at least one of:
one or more security features of the processing path that is selected; and
one or more security features of one or more computing devices responsible for implementing the act of processing the data.

5. One or more computer-readable media as recited in claim 1, wherein the act of selecting comprises:
sequentially evaluating potential processing paths in an order of succession;
eliminating one or more potential processing paths that do not meet requirements associated with the factors; and
identifying the first potential processing path that is not eliminated as the processing path to be selected.

6. One or more computer-readable media as recited in claim 5, wherein the order of succession is based on which processing features each pipeline supports.

7. One or more computer-readable media as recited in claim 1, wherein one or more of the acts are performed by a media player application.

8. A computer-implemented method comprising:
receiving data to be processed;
determining an appropriate processing pipeline to process the data by:
identifying multiple potential processing pipelines as candidates;
sequentially evaluating one or more potential processing pipelines identified as candidates;
eliminating one or more potential processing pipelines as candidates that do not satisfy selection criteria, wherein the selection criteria comprise:
one or more security criteria to determine whether a candidate offers an acceptable level of security for the data;
one or more metadata criteria to determine whether a candidate accommodates requirements associated with metadata for the data;
one or more content criteria to determine whether a candidate accommodates requirements associated with the data item's content; and
selecting the first candidate that is not eliminated; and
processing the data with the appropriate processing pipeline.

9. A computer-implemented method as recited in claim 8, further comprising multiple potential processing pipelines configured to process and render media data.

10. A computer-implemented method as recited in claim 8, wherein the selection criteria further comprises one or more client criteria to determine whether a candidate accommodates requirements of a client utilizing the appropriate processing pipeline.

11. A computer-implemented method as recited in claim 8, wherein receiving data comprises receiving a media data item that is associated with a playlist that specifies a plurality of media data items.

12. A computer-implemented method as recited in claim 8, wherein the one or more security criteria account for one or both of:
one or more security features of the processing path that is selected; and
one or more security features of one or more computing devices responsible for implementing the selected candidate.

13. A computer-implemented method as recited in claim 8, wherein the one or more metadata criteria account for one or more of:
the delivery mechanism of the data;
the format of the data; and
the identification of an appropriate processing pipeline to process the data.

14. A computer-implemented method as recited in claim 8, wherein the one or more content criteria account for one or more of:
the format of the data to be processed; and
processing and presentation features required by the content.

15. A computer-implemented method as recited in claim 8, wherein one or more of the acts of sequentially evaluating, eliminating and selecting are performed by a selection module associated with a media player application.

16. One or more computer-readable media having computer-readable instructions thereon which, when executed by a computer, implement the method of claim 8.

17. An apparatus for processing media information, comprising:
a plurality of media processing pipelines to process and render media information;
a selection module to select a selectable processing pipeline from the plurality of media processing pipelines to process the media information, the selection module selecting the selectable processing pipeline based on one or more client criteria to determine whether a processing pipeline accommodates requirements of a client utilizing the appropriate processing pipeline and two or more of the following:
one or more security criteria to determine whether a processing pipeline offers an acceptable level of security for the media information;
one or more metadata criteria to determine whether a processing pipeline accommodates requirements associated with metadata for the media information; and
one or more content criteria to determine whether a processing pipeline accommodates requirements associated with the content of the media information; and

18. An apparatus for processing media information as recited in claim 17, wherein selecting comprises:
sequentially evaluating one or more of the plurality of media processing pipelines in order;
determining whether each of the evaluated media processing pipelines satisfies the three or more criteria that the selecting is based on;
identifying the first evaluated media processing pipeline that satisfies the three or more criteria as the selectable processing pipeline.

19. An apparatus for processing media information as recited in claim 17, wherein at least two of the plurality of media processing pipelines support one or more of the same features associated with presenting the media information.

20. An apparatus for processing media information as recited in claim 17, further comprising one or more devices for presenting the information for consumption.
